(19) United States
(12) Patent Application Publication
(10) Pub. No.: US 2011/0230629 A1
(43) Pub. Date: Sep. 22, 2011

(54) Impact Resistant LLDPE Composition and Films Made Thereof

(75) Inventors: Shahram Mihan, Bad Soden (DE); Rainer Karer, Kaiserlautern (DE); Fabiana Fantinel, Frankfurt (DE); Manfred Hecker, Neustadt (DE); Gerhardus Meier, Frankfurt (DE); Maclovio Herrera Salinas, Frankfurt am Main (DE)

(73) Assignee: BASELL POLYOLEFINE GMBH, Wesseling (DE)

(21) Appl. No.: 13/120,399

(22) PCT Filed: Sep. 25, 2009
(86) PCT No.: PCT/EP09/06947

§ 371 Date: May 20, 2011

(30) Foreign Application Priority Data
Sep. 25, 2008 (EP) 08016839.6

(51) Int. Cl. C08F 210/14; C08F 2/34; C08F 4/80

(52) U.S. Cl. 526/117; 526/348.5; 526/113

(57) ABSTRACT

Method of polymerizing ethylene with C3-C20-olefine-comonomer, comprising the step of carrying out the olymerization in a single gas phase reactor with a mixed catalyst system herein the catalyst system has a catalyst mileage of higher than 6000 g polymer product/g catalyst.

This application is the U.S. national phase of International Application PCT/EP2009/006947, filed Sep. 25, 2009, claiming priority to European Application 08016839.6 filed Sep. 25, 2008; the disclosures of International Application PCT/EP2009/006947, and European Application 08016839.6, each as filed, are incorporated herein by reference.

The present invention relates to a novel high mileage gas phase polymerisation process.

EP-882077 A from BASF describes gas phase polymerisation of ethylene, in particular with metallocene catalyst. The productivity is acceptable. However, higher productivity, in terms of total yield of product per mass unit of catalyst, would be desireable.

It is the object of the present invention to avoid the disadvantages of the prior art and to devise a higher yielding polymerisation method.

According to the present invention, it is devised a method of polymerizing ethylene with C3-C20-olefine-comonomer, comprising the step of carrying out the polymerization in a single gas phase reactor with a mixed catalyst system wherein the catalyst system has a catalyst mileage of >6000 g polymer product/g catalyst.

According to the present invention, a polyethylene or polyethylene composition is devised that is comprising at least one C3-C20-olefine-comonomer polymerized to ethylene and has a density up to or less than 0.960 g/cm³, preferably of <0.935 g/cm³ and most preferably of <0.922 g/cm³. Said olefine may be an alkene, alkadiene, alkatriene or other polyene having conjugated or non-conjugated double bonds. More preferably, it is an α-olefine having no conjugated double bonds, most preferably it is an 1-alkene.

Preferably, the polyethylene or PE composition of the present invention has a density of from 0.85 to 0.96 g/cm³, more preferably of from 0.90 to 0.935 g/cm³, most preferably of from 0.91 to 0.925 g/cm³ and alone or in combination therewith, preferably it has a melt index (@2.16 kg, 190° C.) measured according to ISO1133:2005 of from 0.1 to 10 g/10 min, preferably of from 0.8 to 5 g/10 min.

Preferably it has a a high load melt index (@21.6 kg, 190° C.) measured according to ISO1133:2005 of from 10 to 100 g/10 min, preferably of from 20 to 50 g/10 min. Further preferred, it has a polydispersity or molecular mass distribution width, MWD with MWD=Mw/Mn, of 2.5<MWD<15, more preferably of 3<MWD<8, most preferably has a MWD of from 3.6<MWD<5. Further preferred, the melt flow rate MFR, sometimes abbreviated FRR: flow rate ratio, and which is defined as MFR(21.6/2.16)=HLMI/MI, is >18 and preferably is 18<MFR<30.

Further prefered, the polyethylene has a weight average molecular weight Mw of from 50,000 up to 500,000 g/mol, preferably of from 100,000 up to 150,000 g/mol, and preferably has a z-average molecular weight Mz of from 200,000 up to 800,000 g/mol. The z-average molecular weight is more sensitive to the very high-molecular weight fractions which are predominantly determining the viscosity and hence melt flow behaviour. Accordingly, as a further dispersity indexer, the Mz/Mw coeffizient may be calculated. Preferably, the polyethylene of the present invention has a Mz/Mw >1.5, preferably >2.

More preferably, said polyethylene is at least bimodal in comonomer distribution, as analyzed preferably by CRYSTAF®. Modality, and multimodality respectively, is to be construed in terms of distinct maxima discernible in the CRYSTAF® distribution curve. Preferably, the polyethylene has a high temperature peak weight fraction (% HT) , of from 1 up to 40% of the total weight of the polyethylene composition as determined from CRYSTAF® analysis, that is by the integral of the CRYSTAF® distribution curve in terms of said % HT being the share of polymer above a temperature threshold of 80° C. (for T>80° C. for short), more preferably the polyethylene has a %HT of from 5 up to 30% of total weight, again more preferably of from 10% to 28% and most preferably of from 15% to 25% of total weight of the composition, and further the polyethylene has a low temperature peak weight fraction (% LT) as likewise determined by CRYSTAF® analysis for the share of polymer below a temperature threshold of 80° C. (for T<80° C. for short), of from 95% up to 70% of the total weight of the composition.

The molar mass distribution width (MWD) or polydispersity is defined as Mw/Mn. Definition of Mw, Mn , Mz, MWD can be found in the ‘Handbook of PE’, ed. A. Peacock, p.7-10, Marcel Dekker Inc. , New York/Basel 2000. The determination of the molar mass distributions and the means Mn, Mw and Mw/Mn derived therefrom was carried out by high-temperature gel permeation chromatography using a method described in DIN 55672-1:1995-02 issue February 1995. The deviations according to the mentioned DIN standard are as follows: Solvent 1,2,4-trichlorobenzene (TCB), temperature of apparatus and solutions 135° C. and as concentration detector a PolymerChar (Valencia, Paterna 46980, Spain) IR-4 infrared detector, capable for use with TCB.

A WATERS Alliance 2000 equipped with the following precolumn SHODEX UT-G and separation columns SHODEX UT 806 M (3×) and SHODEX UT 807 connected in series was used. The solvent was vacuum destilled under Nitrogen and was stabilized with 0.025% by weight of 2,6-di-tert-butyl-4-methylphenol. The flowrate used was 1 ml/min, the injection was 500 μl and polymer concentration was in the range of 0.01% <conc. <0.05% w/w. The molecular weight calibration was established by using monodisperse polystyrene (PS) standards from Polymer Laboratories (now Varian, Inc., Essex Road, Church Stretton, Shropshire, SY6 6AX,UK) in the range from 5808/mol up to 11600000 g/mol and additionally Hexadecane. The calibration curve was then adapted to Polyethylene (PE) by means of the Universal Calibration method (Benoit H., Rempp P. and Grubisic Z., in J. Polymer Sci., Phys. Ed., 5, 753(1967)). The Mark-Houwing parameters used herefore were for PS: kPS=0.000121 dl/g, αPS=0.706 and for PE kPE=0.000406 dl/g, αPE=0.725, valid in TCB at 135° C. Data recording, calibration and calculation was carried out using NTGPC_Control_V6.02.03 and NTGPC_V6.4.24 (HS -Entwicklungsgesellschaft fur wissenschaftliche Hard-und Software mbH , Hauptstraβe 36, D-55437 Ober-Hilbersheim) respectively. Further with relevance to smooth, convenient extrusion processing at low pressure, preferably the amount of the polyethylene of the invention with a molar mass of <1 million g/mol, as determined by GPC for standard determination of the molecular weight distribution, is preferably above 95.5% by weight. This is determined in the usual course of the molar mass distribution measurement by applying the WIN-GPC' software of the company ‘HS-Entwicklungsgesellschaft fur wissenschaftliche Hard-und Software mbH’, Ober-Hilbersheim/Germany, see supra.

Typically, in a preferred embodiment of the present invention, the polyethylene comprises at least two, preferably substantially just two, different polymeric subfractions preferably synthesized by different catalysts, namely a first preferably non-metallocene one its polymeric subfraction having a lower and/or no comonomer contents, a high elution temperature (% HT mass fraction) and having preferably a broader molecular weight distribution, and a second, preferably metallocene one, its polymeric subfraction having a higher comonomer contents, a more narrow molecular weight distribution, a lower elution temperature (% LT mass fraction) and, optionally, a lower vinyl group contents.

The polyethylene of the present invention, whilst and despite preferably being bimodal or at least bimodal in comonomer distribution as said above, may be a monomodal or multimodal polyethylene in mass distribution analysis by high temperature gel permeation chromatography analysis (high temperature GPC for polymers according to the method described in DIN 55672-1:1995-02 issue February 1995 with specific deviations made as said above, see section on determining Mw,Mn by means of HT-GPC). The molecular weight distribution curve of a GPC-multimodal polymer can be looked at as the superposition of the molecular weight distribution curves of the polymer subfractions or subtypes which will accordingly show two or more distinct curve maxima instead of the single peaks found in the mass curves for the individual fractions. A polymer showing such a molecular weight distribution curve is called ‘bimodal’ or ‘multimodal’ with regard to GPC analysis, respectively.

The polyethylene or PE composition of the present invention is obtainable using the catalyst system described below and in particular its preferred embodiments. Preferably, the polymerization reaction is carried out with a catalyst composition comprising two catalysts, preferably comprising at least two transition metal complex catalysts, more preferably comprising just two transition metal complex catalysts, and preferably in substantially a single reactor system. This one-pot reaction approach provides for an unmatched homogeneity of the product thus obtained from the catalyst systems employed. In the present context, a bi- or multizonal reactor providing for circulation or substantially free flow of product in between the zones, at least from time to time and into both directions, is considered a single reactor or single reactor system according to the present invention.

For the polymerization method of the present invention for devising the polyethylene or polyethylene composition in suit, further it is preferred that a first catalyst is a single site catalyst or catalyst system, preferably is a metallocene catalyst A) including half-sandwich or mono-sandwich metallocene catalysts having single-site characteristic, and which first catalyst is providing for a first product fraction which makes up for the % LT peak weight fraction, and further preferably wherein a second catalyst B) is a non-metallocene catalyst or catalyst system, more preferably said second catalyst being a non-single site metal complex catalyst which preferably is providing for a second product fraction which makes up for the % HT peak weight fraction. More preferably, in one embodiment of the present invention, B) preferably is at least one iron complex component B1) which iron complex preferably has a tridentate ligand.

In another preferred embodiment, the non-metallocene polymerization catalyst B) is a monocyclopentadienyl complex catalyst of a metal of groups 4 to 6 of the Periodic Table of the Elements B2), preferably of a metal selected from the group consisting of Ti, V, Cr, Mo and W, cyclopentadienyl system is substituted by an uncharged donor. Suitable mono-cyclopentadienyl catalyst having non-single site, polydispers product characteristics when copolymerizing ethylene with olefine comonomers, especially C3-C20 comonomers, most preferably C3-C10 comonomers, are described in EP-1572755-A. More preferably said complex catalyst is a complex of chromium in the oxidation states 2, 3 and 4, most preferably of chromium in the oxidation state 3. The non-single site characteristic is a functional descriptor for any such complex B2) as described in the foregoing since it is highly dependent on the specific combination and connectivity, of aromatic ligands chosen.

Preferably, the first and/or metallocene catalyst A) is at least one Zirconocene catalyst or catalyst system. Zirconocene catalysts according to the present invention are, for example, cyclopentadienyl complexes. The cyclopentadienyl complexes can be, for example, bridged or unbridged biscyclopentadienyl complexes as described, for example, in EP 129 368, EP 561 479, EP 545 304 and EP 576 970, bridged or unbridged monocyclopentadienyl ‘half-sandwich’ complexes such as e.g. bridged amidocyclopentadienyl complexes described in EP 416 815 or half-sandwich complexes described in U.S. Pat. No. 6,069,213, U.S. Pat. No. 5,026,798,further can be multinuclear cyclopentadienyl complexes as described in EP 632 063, pi-ligand-substituted tetrahydropentalenes as described in EP 659 758 or pi-ligand-substituted tetrahydroindenes as described in EP 661 300.

Non-limiting examples of metallocene catalyst components consistent with the description herein include, for example: cyclopentadienylzirconiumdichloride, indenylzirconiumdichloride, (1-methylindenyl)zirconiumdichloride, (2-methylindenyl)zirconiumdichloride, (1-propylindenyl)zirconiumdichloride, (2-propylindenyl)zirconiumdichloride, (1-butylindenyl)zirconiumdichloride, (2-butylindenyl)zirconiumdichloride, methylcyclopentadienylzirconiumdichloride, tetrahydroindenylzirconiumdichloride, pentamethylcyclopentadienylzirconiumdichloride, cyclopentadienylzirconiumdichloride, pentamethylcyclopentadienyltitaniumdichloride, tetramethylcyclopentyltitaniumdichloride, (1,2,4-trimethylcyclopentadienyl)zirconiumdichloride, dimethylsilyl(1,2,3,4-tetramethylcyclopentadienyl)(cyclopentadienyl)zirconiumdichloride, dimethylsilyl(1,2,3,4-tetramethylcyclopentadienyl)(1,2,3-trimethylcyclopentadienyl)zirconiumdichloride, dimethylsilyl(1,2,3,4-tetramethylcyclopentadienyl)(1,2-dimethylcyclopentadienyl)zirconiumdichloride, dimethylsilyl(1,2,3,4-tetramethylcyclopentadienyl)(2-methylcyclopentadienyl)zirconiumdichloride, dimethylsilylcyclopentadienylindenylzirconium dichloride, dimethylsilyl(2-methylindenyl)(fluorenyl)zirconiumdichloride, diphenylsilyl(1,2,3,4-tetramethylcyclopentadienyl)(3-propylcyclopentadienyl)zirconiumdichloride.

Particularly suitable zirconocenes (A) are Zirconium complexes of the general formula (I)

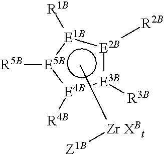

where the substituents and indices have the following meanings:
X^{B} is fluorine, chlorine, bromine, iodine, hydrogen, C1-C10-alkyl, C2-C10-alkenyl, C6-C15-aryl, alkylaryl having from 1 to 10 carbon atoms in the alkyl part and from 6 to 20 carbon atoms in the aryl part, —OR6B or —NR6BR7B, or two radicals XB form a substituted or unsubstituted diene ligand, in particular a 1,3-diene ligand, and the radicals XB are identical or different and may be joined to one another,
E1B-E5B are each carbon or not more than one E1B to E5B is phosphorus or nitrogen, preferably carbon,
t is 1, 2 or 3 and is, depending on the valence of Hf, such that the metallocene complex of the general formula (VI) is uncharged,
   where
R6B and R7B are each C1-C10-alkyl, C6-C15-aryl, alkylaryl, arylalkyl, fluoroalkyl or fluoroaryl each having from 1 to 10 carbon atoms in the alkyl part and from 6 to 20 carbon atoms in the aryl part and
R1B to R5B are each, independently of one another hydrogen, C1-C22-alkyl, 5- to 7-membered cycloalkyl or cycloalkenyl which may in turn bear C1-C10-alkyl groups as substituents, C2-C22-alkenyl, C6-C22-aryl, arylalkyl having from 1 to 16 carbon atoms in the alkyl part and from 6 to 21 carbon atoms in the aryl part, NR8B2, N(SiR8B3)2, OR8B, OSiR8B3, SiR8B3, where the organic radicals R1B-R5B may also be substituted by halogens and/or two radicals R1B-R5B, in particular vicinal radicals, may also be joined to form a five-, six- or seven-membered ring, and/or two vicinal radicals R1D-R5D may be joined to form a five-, six- or seven-membered heterocycle containing at least one atom from the group consisting of N, P, O and S, where
   the radicals R8B can be identical or different and can each be C1-C10-alkyl, C3-C10-cycloalkyl, C6-C15-aryl, C1-C4-alkoxy or C6-C10-aryloxy and Z1B is XB or

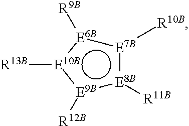

where the radicals
R9B to R13B are each, independently of one another, hydrogen, C1-C22-alkyl, 5- to 7-membered cycloalkyl or cycloalkenyl which may in turn bear C1-C10-alkyl groups as substituents, C2-C22-alkenyl, C6-C22-aryl, arylalkyl having from 1 to 16 carbon atoms in the alkyl part and 6-21 carbon atoms in the aryl part, NR14B2, N(SiR14B3)2, OR14B, OSiR14B3, SiR14B3, where the organic radicals R9B-R13B may also be substituted by halogens and/or two radicals R9B-R13B, in particular vicinal radicals, may also be joined to form a five-, six- or seven-membered ring, and/or two vicinal radicals R9B-R13B may be joined to form a five-, six- or seven-membered heterocycle containing at least one atom from the group consisting of N, P, O and S, where
the radicals R14B are identical or different and are each C1-C10-alkyl, C3-C10-cycloalkyl, C6-C15-aryl, C1-C4-alkoxy or C6-C10-aryloxy,
E6B-E1OB are each carbon or not more than one E6B to E1OB is phosphorus or nitrogen, preferably carbon,
   or where the radicals R4B and Z1B together form an -R15Bv-A1B-group, where
R15B is

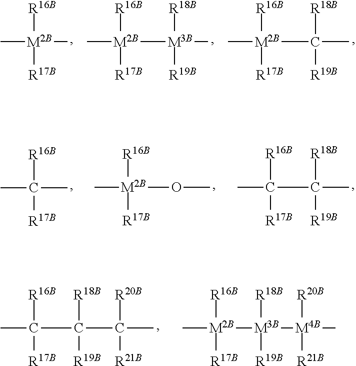

### or is =BR16B, =BNR16BR17B, =AlR16B, —Ge(II)-, —Sn(II)-, —O—, —S—, =SO, =SO2, =NR16B, =CO, =PR16B or =P(O)R16B,

where
R16B-R21B are identical or different and are each a hydrogen atom, a halogen atom, a trimethylsilyl group, a C1-C10-alkyl group, a C1-C10-fluoroalkyl group, a C6-C10-fluoroaryl group, a C6-C10-aryl group, a C1-C10-alkoxy group, a C7-C15-alkylaryloxy group, a C2-C10-alkenyl group, a C7-C40-arylalkyl group, a C8-C40-arylalkenyl group or a C7-C40-alkylaryl group or two adjacent radicals together with the atoms connecting them form a saturated or unsaturated ring having from 4 to 15 carbon atoms, and
M2B-M4B are independently each Si, Ge or Sn, preferably are Si,
A1B is —O—, —S—,

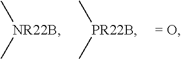

=S, =NR22B, —O—R22B, —NR22B2 , -PR22B2 or an unsubstituted, substituted or fused, heterocyclic ring system, where
the radicals R22B are each, independently of one another, C1-C10-alkyl, C6-C15-aryl, C3-C10-cycloalkyl, C7-C18-alkylaryl or Si(R23B)3,
R23B is hydrogen, C1-C10-alkyl, C6-C15-aryl which may in turn bear C1-C4-alkyl groups as substituents or C3-C10-cycloalkyl,
v is 1 or when A1B is an unsubstituted, substituted or fused, heterocyclic ring system may also be 0
   or where the radicals R4B and R12B together form an -R15B- group.

A1B can, for example together with the bridge R15B, form an amine, ether, thioether or phosphine. However, A1B can also be an unsubstituted, substituted or fused, heterocyclic aromatic ring system which can contain heteroatoms from the group consisting of oxygen, sulfur, nitrogen and phosphorus in addition to ring carbons. Examples of 5-membered heteroaryl groups which can contain from one to four nitrogen atoms and/or a sulfur or oxygen atom as ring members in addition to carbon atoms are 2-furyl, 2-thienyl, 2-pyrrolyl, 3-isoxazolyl, 5-isoxazolyl, 3-isothiazolyl, 5-isothiazolyl, 1-pyrazolyl, 2-oxazolyl. Examples of 6-membered heteroaryl groups which may contain from one to four nitrogen atoms and/or a phosphorus atom are 2-pyridinyl, 2-phosphabenzenyl, 3-pyridazinyl, 2-pyrimidinyl, 4-pyrimidinyl, 2-pyrazinyl, 1,3,5-triazin-2-yl. The 5-membered and 6-membered heteroaryl groups may also be substituted by C1-C10-alkyl, C6-C10-aryl, alkylaryl having from 1 to 10 carbon atoms in the alkyl part and 6-10 carbon atoms in the aryl part, trialkylsilyl or halogens such as fluorine, chlorine or bromine or be fused with one or more aromatics or heteroaromatics. Examples of benzo-fused 5-membered heteroaryl groups are 2-indolyl, 7-indolyl, 2-coumaronyl. Examples of benzo-fused 6-membered heteroaryl groups are 2-quinolyl, 8-quinolyl, 3-cinnolyl, 1-phthalazyl, 2-quinazolyl and 1-phenazyl. Naming and numbering of the heterocycles has been taken from L. Fieser and M. Fieser, Lehrbuch der organischen Chemie, 3rd revised edition, Verlag Chemie, Weinheim 1957.

The radicals XB in the general formula (I) are preferably identical, preferably fluorine, chlorine, bromine, C1-C7-alkyl or aralkyl, in particular chlorine, methyl or benzyl.

Among the zirconocenes of the general formula (I), those of the formula (II)

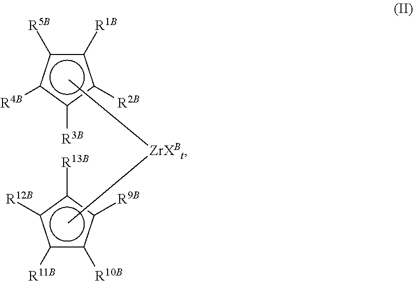

are preferred.

Among the compounds of the formula (II), preference is given to those in which
XB is fluorine, chlorine, bromine, C1-C4-alkyl or benzyl, or two radicals XB form a substituted or unsubstituted butadiene ligand,
t is 1 or 2, preferably 2,
R1B to R5B are each hydrogen, C1-C8-alkyl, C6-C8-aryl, NR8B2, OSiR8B3 or Si(R8B)3 and
R9B to R13B are each hydrogen, C1-C8-alkyl or C6-C8-aryl, NR14B2, OSiR14B3 or Si(R14B)3
   or in each case two radicals R1B to R5B and/or R9B to R13B together with the C5 ring form an indenyl, fluorenyl or substituted indenyl or fluorenyl system.

The zirconocenes of the formula (II) in which the cyclopentadienyl radicals are identical are particularly useful for the polymerisation method of the present patent.

The synthesis of such complexes can be carried out by methods known per se, with the reaction of the appropriately substituted cyclic hydrocarbon anions with halides of Zirconium being preferred. Examples of appropriate preparative methods are described, for example, in Journal of Organometallic Chemistry, 369 (1989), 359-370.

The metallocenes can be used in the Rac or pseudo-Rac form. The term pseudo-Rac refers to complexes in which the two cyclopentadienyl ligands are in the Rac arrangement relative to one another when all other substituents of the complex are disregarded.

Preferably, the second catalyst or catalyst system B) is at least one polymerization catalyst based on an iron component having a tridentate ligand bearing at least two aryl radicals, more preferably wherein each of said two aryl radicals bears a halogen and/or an alkyl substituent in the ortho-position, preferably wherein earch aryl radical bears both a halogen and an alkyl substituent in the ortho-positions.

Suitable catalysts B) preferaby are iron catalyst complexes B1) of the general formulae (IIIa):

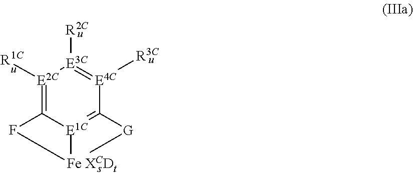

wherein the variables have the following meaning:
F and G, independently of one another, are selected from the group consisting of:

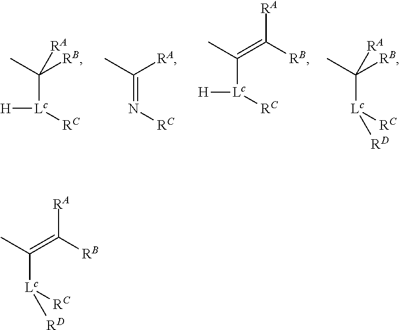

wherein Lc is nitrogen or phosphor, preferably is nitrogen,
and further wherein preferably at least one of F and G is an enamine or imino radical as selectable from above said group, with the proviso that where F is imino, then G is imino with G, F each bearing at least one aryl radical with each bearing a halogen or a tert. alkyl substituent in the ortho-position, together giving rise to the tridentate ligand of formula IIIa, or then G is enamine, more preferably that at least F or G or both are an enamine radical as selectable from above said group or that both F and G are imino, with G, F each bearing at least one, preferably precisely one, aryl radical with each said aryl radical bearing at least one halogen or at least one C1-C22 alkyl substituent, preferably precisely one halogen or one C1-C22 alkyl, in the ortho-position,
R1C-R3C are each, independently of one another, hydrogen C1-C22-alkyl, C2-C22-alkenyl, C6-C22-aryl, alkylaryl having from 1 to 10 carbon atoms in the alkyl part and 6-20 carbon atoms in the aryl part, halogen, NR18C2, OR18C, SiR19C3, where the organic radicals R1C-R3C may also be substituted by halogens and/or two vicinal radicals R1C-R3C may also be joined to form a five-, six- or seven-membered ring, and/or two vicinal radicals R1C-R3C are joined to form a five-, six- or seven-membered heterocycle containing at least one atom from the group consisting of N, P, O and S,
RA,RB independently of one another denote hydrogen, C1-C20-alkyl, C2-C20-alkenyl, C6-C20-aryl, arylalkyl having 1 to 10 C atoms in the alkyl radical and 6 to 20 C atoms in the aryl radical, or SiR19C3, wherein the organic radicals RA,RB can also be substituted by halogens, and/or in each case two radicals RA,RB can also be bonded with one another to form a five- or six-membered ring,
RC,RD independently of one another denote C1-C20-alkyl, C2-C20-alkenyl, C6-C20-aryl, arylalkyl having 1 to 10 C atoms in the alkyl radical and 6 to 20 C atoms in the aryl radical, or SiR19C3, wherein the organic radicals RC,RD can also be substituted by halogens, and/or in each case two radicals RC,RD can also be bonded with one another to form a five- or six-membered ring,
E1C is nitrogen or phosphorus, preferably is nitrogen,
E2C-E4C are each, independently of one another, carbon, nitrogen or phosphorus and preferably with the proviso that where E1C is phosphorus, then E2C-E4C are carbon each, more preferably they are carbon or nitrogen and preferably with the proviso that 0,1 or 2 selected from the group E2C-E4C may be nitrogen, most preferably E2C-E4C are carbon each.
u is 0 when the corresponding E2C-E4C is nitrogen or phosphorus and is 1 when E2C-E4C is carbon,
   and wherein the radicals R18C, R19C, XC are defined in and for formula IIIa above identically as given for formula III below,
D is an uncharged donor and
s is 1, 2, 3 or 4,
t is 0 to 4.

The three atoms E2C to E4C in a molecule can be identical or different. If E1C is phosphorus, then E2C to E4C are preferably carbon each. If E1C is nitrogen, then E2C to E4C are each preferably nitrogen or carbon, in particular carbon.

In a preferred embodiment the complexes (B) are of formula (IV)

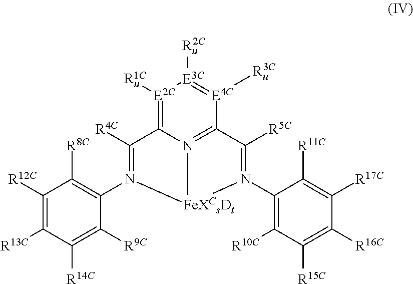

where
E2C-E4C are each, independently of one another, carbon, nitrogen or phosphorus , preferably are carbon or nitrogen, more preferably 0,1 or 2 of E2C-E4C are nitrogen with the proviso that the remaining radicals E2C-E4C≠nitrogen are carbon, most preferably they are carbon each,
R1C-R3C are each, independently of one another, hydrogen, C1-C22-alkyl, C2-C22-alkenyl, C6-C22-aryl, alkylaryl having from 1 to 10 carbon atoms in the alkyl part and 6-20 carbon atoms in the aryl part, halogen, NR18C2, OR18C, SiR19C3, where the organic radicals R1C-R3C may also be substituted by halogens and/or two vicinal radicals R1C-R3C may also be joined to form a five-, six- or seven-membered ring, and/or two vicinal radicals R1C-R3C are bound to form a five-, six- or seven-membered heterocycle containing at least one atom from the group consisting of N, P, O and S,
R4C-R5C are each, independently of one another, hydrogen, C1-C22-alkyl, C2-C22-alkenyl, C6-C22-aryl, alkylaryl having from 1 to 10 carbon atoms in the alkyl part and 6-20 carbon atoms in the aryl part, NR18C2, SiR19C3, where the organic radicals R4C-R5C may also be substituted by halogens,
u is 0 when E2C-E4C is nitrogen or phosphorus and is 1 when E2C-E4C is carbon,
R8C-R11C are each, independently of one another, halogen selected from the group consisting of chlorine, bromine, fluorine, C1-C22-alkyl, C2-C22-alkenyl, C6-C22-aryl, alkylaryl having from 1 to 10 carbon atoms in the alkyl part and 6-20 carbon atoms in the aryl part, halogen, NR18C2, OR18C, SiR19C3, where the organic radicals R8C-R11C may also be substituted by halogens and/or two vicinal radicals R8C-R17C may also be joined to form a five-, six- or seven-membered ring, and/or two vicinal radicals R8C-R17C are joined to form a five-, six- or seven-membered heterocycle containing at least one atom from the group consisting of N, P, O and S, and wherein R9C, R11C may be hydrogen with the proviso that at least R8C and R10C are halogen or a C1-C22-alkyl group,
R12C-R17C are each, independently of one another, hydrogen, C1-C22-alkyl, C2-C22-alkenyl, C6-C22-aryl, alkylaryl having from 1 to 10 carbon atoms in the alkyl part and 6-20 carbon atoms in the aryl part, halogen, NR18C2, OR18C, SiR19C3, where the organic radicals R12C-R17C may also be substituted by halogens and/or two vicinal radicals R8C-R17C may also be joined to form a five-, six- or seven-membered ring, and/or two vicinal radicals R8C-R17C are joined to form a five-, six- or seven-membered heterocycle containing at least one atom from the group consisting of N, P, O or S,
   the indices v are each, independently of one another, 0 or 1,
the radicals XC are each, independently of one another, fluorine, chlorine, bromine, iodine, hydrogen, C1-C10-alkyl, C2-C10-alkenyl, C6-C20-aryl, alkylaryl having 1-10 carbon atoms in the alkyl part and 6-20 carbon atoms in the aryl part, NR18C2, OR18C, SR18C , SO3R18C, OC(O)R18C, CN, SCN, β-diketonate, CO, BF4⁻, PF6⁻ or a bulky noncoordinating anion and the radicals XC may be joined to one another,
the radicals R18C are each, independently of one another, hydrogen, C1-C20-alkyl, C2-C20-alkenyl, C6-C20-aryl, alkylaryl having from 1 to 10 carbon atoms in the alkyl part and 6-20 carbon atoms in the aryl part, SiR19C3, where the organic radicals R18C may also be substituted by halogens and nitrogen- and oxygen-containing groups and two radicals R18C may also be joined to form a five- or six-membered ring,
the radicals R19C are each, independently of one another, hydrogen, C1-C20-alkyl, C2-C20-alkenyl, C6-C20-aryl, alkylaryl having from 1 to 10 carbon atoms in the alkyl part and 6-20 carbon atoms in the aryl part, where the organic radicals R19C may also be substituted by halogens or nitrogen- and oxygen-containing groups and two radicals R19C may also be joined to form a five- or six-membered ring,
s is 1, 2, 3 or 4, in particular 2 or 3,
D is an uncharged donor and
t is from 0 to 4, in particular 0, 1 or 2.

The ligands XC result, for example, from the choice of the appropriate starting metal compounds used for the synthesis of the iron complexes, but can also be varied afterward. Possible ligands XC are, in particular, the halogens such as fluorine, chlorine, bromine or iodine, in particular chlorine. Alkyl radicals such as methyl, ethyl, propyl, butyl, vinyl, allyl, phenyl or benzyl are also usable ligands XC. Amides, alkoxides, sulfonates, carboxylates and diketonates are also particularly useful ligands XC. As further ligands XC, mention may be made, purely by way of example and in no way exhaustively, of trifluoroacetate, BF4⁻, PF6⁻ and weakly coordinating or noncoordinating anions (cf., for example, S. Strauss in Chem. Rev. 1993, 93, 927-942), e.g. B(C6F5)4⁻. Thus, a particularly preferred embodiment is that in which XC is dimethylamide, methoxide, ethoxide, isopropoxide, phenoxide, naphthoxide, triflate, p-toluenesulfonate, acetate or acetylacetonate. The number s of the ligands XC depends on the oxidation state of the iron. Preference is given to using iron complexes in the oxidation state +3 or +2.

D is an uncharged donor, in particular an uncharged Lewis base or Lewis acid, for example amines, alcohols, ethers, ketones, aldehydes, esters, sulfides or phosphines which may be bound to the iron center or else still be present as residual solvent from the preparation of the iron complexes. The number t of the ligands D can be from 0 to 4 and is often dependent on the solvent in which the iron complex is prepared and the time for which the resulting complexes are dried and can therefore also be a nonintegral number such as 0.5 or 1.5. In particular, t is 0, 1 to 2.

Preferred complexes B) are 2,6-Bis[1-(2-tert.butylphenylimino)ethyl]pyridine iron(II) dichloride, 2,6-Bis[1-(2-tert.butyl-6-chlorophenylimino)ethyl]pyridine iron(II) dichloride, 2,6-Bis[1-(2-chloro-6-methylphenylimino)ethyl]pyridine pyridine iron(II) dichloride, 2,6-Bis[1-(2,4-dichlorophenylimino)ethyl]-pyridine iron(II) dichloride, 2,6-Bis[1-(2,6-dichlorophenylimino)ethyl]pyridine iron(II) dichloride, 2,6-Bis[1-(2,4-dichlorophenylimino)methyl]pyridine iron(II) dichloride, 2,6-Bis[1-(2,4-dichloro-6-methylphenylimino)ethyl]pyridine iron(II) dichloride2,6-Bis[1-(2,4-difluorophenylimino)ethyl]-pyridine iron(II) dichloride, 2,6-Bis[1-(2,4-dibromophenylimino)ethyl]pyridine iron(II) dichloride or the respective trichlorides, dibromides or tribromides. The preparation of the compounds B) is described, for example, in J. Am. Chem. Soc. 120, p. 4049 ff. (1998), J. Chem. Soc., Chem. Commun. 1998, 849, and WO 98/27124.

The molar ratio of transition metal complex A), that is the single site catalyst producing a narrow MWD distribution, to polymerization catalyst B) producing a broad MWD distribution, is usually in the range from 100-1:1, preferably from 20-5:1 and particularly preferably from 1:1 to 5:1.

In a preferred embodiment of the invention, the catalyst system comprises at least one activating compound (C). They are preferably used in an excess or in stoichiometric amounts based on the catalysts which they activate. In general, the molar ratio of catalyst to activating compound (C) can be from 1:0.1 to 1:10000. Such activator compounds are uncharged, strong Lewis acids, ionic compounds having a Lewis-acid cation or a ionic compounds containing a Bronsted acid as cation in general. Further details on suitable activators of the polymerization catalysts of the present invention, especially on definition of strong, uncharged Lewis acids and Lewis acid cations, and preferred embodiments of such activators, their mode of preparation as well as particularities and the stoichiometrie of their use have already been set forth in detail in WO05/103096 from the same applicant. Examples are aluminoxanes, hydroxyaluminoxanes, boranes, boroxins, boronic acids and borinic acids. Further examples of strong, uncharged Lewis acids for use as activating compounds are given in WO 03/31090 and WO05/103096 incorporated hereto by reference.

Suitable activating compounds (C) are both as an example and as a strongly preferred embodiment, compounds such as an aluminoxane, a strong uncharged Lewis acid, an ionic compound having a Lewis-acid cation or an ionic compound containing. Most preferably, it is an aluminoxane. As aluminoxanes, it is possible to use the compounds described in WO 00/31090 incorporated hereto by reference. Particularly useful aluminoxanes are open-chain or cyclic aluminoxane compounds of the general formula (III) or (IV)

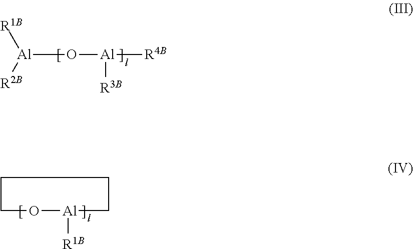

where R1B-R4B are each, independently of one another, a C1-C6-alkyl group, preferably a methyl, ethyl, butyl or isobutyl group and I is an integer from 1 to 40, preferably from 4 to 25.

A particularly useful aluminoxane compound is methyl aluminoxane (MAO).

Boranes and boroxines are also particularly useful as activating compound (C), such as trialkylborane, triarylborane or trimethylboroxine. Particular preference is given to using boranes which bear at least two perfluorinated aryl radicals. More preferably, a compound selected from the list consisting of triphenylborane, tris(4-fluorophenyl)borane, tris(3,5-difluorophenyl)borane, tris(4-fluoromethylphenyl)borane, tris(pentafluorophenyl)borane, tris(tolyl)borane, tris(3,5-dimethylphenyl)borane, tris(3,5-difluorophenyl)borane or tris(3,4,5-trifluorophenyl)borane is used, most preferably the activating compound is tris(pentafluorophenyl)borane. Particular mention is also made of borinic acids having perfluorinated aryl radicals, for example (C6F5)2BOH. More generic definitions of suitable Bor-based Lewis acids compounds that can be used as activating compounds (C) are given WO05/103096 incorporated hereto by reference, as said above.

Compounds containing anionic boron heterocycles as described in WO 9736937 incorporated hereto by reference, such as for example dimethyl anilino borato benzenes or trityl borato benzenes, can also be used suitably as activating compounds (C). Preferred ionic activating compounds (C) can contain borates bearing at least two perfluorinated aryl radicals. Particular preference is given to N,N-dimethyl anilino tetrakis(pentafluorophenyl)borate and in particular N,N-dimethylcyclohexylammonium tetrakis(pentafluorophenyl)borate, N,N-dimethylbenzylammonium tetrakis(pentafluorophenyl)borate or trityl tetrakispentafluorophenylborate. It is also possible for two or more borate anions to be joined to one another, as in the dianion [(C6F5)2B-C6F4-B(C6F5)2]2-, or the borate anion can be bound via a bridge to a suitable functional group on the support surface. Further suitable activating compounds (C) are listed in WO 00/31090, here incorporated by reference.

Further specially preferre activating compounds (C) preferably include boron-aluminum compounds such as di[bis(pentafluorophenylboroxy)]methylalane. Examples of such boron-aluminum compounds are those disclosed in WO 99/06414 incorporated hereto by reference. It is also possible to use mixtures of all the above-mentioned activating compounds (C). One prefered such embodiment are mixtures that comprise aluminoxanes, in particular methylaluminoxane, and an ionic compound, in particular one containing the tetrakis(pentafluorophenyl)borate anion, and/or a strong uncharged Lewis acid, in particular tris(pentafluorophenyl)borane or a boroxin.

The catalyst system may further comprise, as additional component (K), a metal compound as defined both by way of generic formula, its mode and stoichiometrie of use and specific examples in WO 05/103096, incorporated hereto by reference. The metal compound (K) can likewise be reacted in any order with the catalysts (A) and (B) and optionally with the activating compound (C) and the support (D).

Combinations of the preferred embodiments of (C) with the preferred embodiments of the metallocene (A) and/or the transition metal complex (B) are particularly preferred, for sustaining a high and lasting specific activity. As joint activator (C) for the catalyst component (A) and (B), preference is given to using an aluminoxane. Preference is also given to the combination of salt-like compounds of the cation of the general formula (XIII), in particular N,N-dimethylanilinium tetrakis(pentafluorophenyl)borate, N,N-dimethylcyclohexylammonium tetrakis(pentafluorophenyl)borate, N,N-dimethylbenzylammonium tetrakis(pentafluorophenyl)borate or trityl tetrakispentafluorophenylborate, as activator (C) for zirconocenes (A), in particular and most preferably in combination with an aluminoxane as activator (C) for the iron complex (B1).

To enable the metallocene (A) and the iron or other transition metal complex (B) to be used in polymerization processes in the gas phase, it is preferred to use the complexes in the form of a solid. The metallocene (A) and/or the iron complex (B) are therefore preferably immobilized on an organic or inorganic, solid support (D) and be used in such supported form in the polymerization. This enables deposits in the reactor to be avoided and the polymer morphology to be controlled. As support materials, preference is given to using silica gel, magnesium chloride, aluminum oxide, mesoporous materials, aluminosilicates, hydrotalcites and organic polymers such as polyethylene, polypropylene, polystyrene, polytetrafluoroethylene or polymers bearing polar functional groups, for example copolymers of ethene and acrylic esters, acrolein or vinyl acetate. An inorganic support (D) is strongly preferred. (A) and (B) are even more preferably applied to a common or joint support in order to ensure a relatively close spatial proximity of the different catalyst centres and thus to ensure good mixing of the different polymer products formed. Moreover, an inorganic support (D) is strongly preferred as a joint support, too.

Metallocene (A), iron or other transition metal complex (B) and the activating compound (C) can be immobilized independently of one another, e.g. in succession or simultaneously. Thus, the support component (D) can firstly be brought into contact with the activating compound or compounds (C) or the support component (D) can firstly be brought into contact with the transition metal complex (A) and/or the complex (B). Preactivation of the transition metal complex A) by means of one or more activating compounds (C) prior to mixing with the support (D) is also possible. The iron component can, for example, be reacted simultaneously with the transition metal complex with the activating compound (C), or can be preactivated separately by means of the latter. The preactivated complex (B) can be applied to the support before or after the preactivated metallocene complex (A). In one possible embodiment, the complex (A) and/or the complex (B) can also be prepared in the presence of the support material. A further method of immobilization is prepolymerization of the catalyst system with or without prior application to a support. A further preferred embodiment comprises firstly producing the activating compound (C) on the support component (D) and subsequently bringing this supported compound into contact with the transition metal complex (A) and the iron or other transition metal complex (B).

The immobilization is generally carried out in an inert solvent which can be removed by filtration or evaporation after the immobilization. After the individual process steps, the solid can be washed with suitably inert solvents such as aliphatic or aromatic hydrocarbons and dried. However, the use of the still moist, supported catalyst is also possible. The supported catalyst is preferably obtained as a free-flowing powder. Examples of the industrial implementation of the above process are described in WO 96/00243, WO 98/40419 or WO 00/05277.

The support materials used preferably have a specific surface area in the range from 10 to 1000 m2/g, a pore volume in the range from 0.1 to 5 ml/g and a mean particle size of from 1 to 500 μm. Preference is given to supports having a specific surface area in the range from 50 to 700 m2/g, a pore volume in the range from 0.4 to 3.5 ml/g and a mean particle size in the range from 5 to 350 μm. Particular preference is given to supports having a specific surface area in the range from 200 to 550 m2/g, a pore volume in the range from 0.5 to 3.0 ml/g and a mean particle size of from 10 to 150 μm.

The metallocene complex (A) is preferably applied in such an amount that the concentration of the transition metal from the transition metal complex (A) in the finished catalyst system is from 1 to 200 μmol, preferably from 5 to 100 μmol and particularly preferably from 10 to 70 μmol, per g of support (D). The e.g. iron complex (B) is preferably applied in such an amount that the concentration of iron from the iron complex (B) in the finished catalyst system is from 1 to 200 μmol, preferably from 5 to 100 μmol and particularly preferably from 10 to 70 μmol, per g of support (D).

Inorganic oxides suitable as inorganic support (D) may be found among the oxides of elements of groups 2, 3, 4, 5, 13, 14, 15 and 16 of the Periodic Table of the Elements. Examples of oxides preferred as supports include silicones, dioxide, aluminum oxide and mixed oxides of the elements calcium, aluminum, silicium, magnesium or titanium and also corresponding oxide mixtures. Other inorganic oxides which can be used alone or in combination with the abovementioned preferred oxidic supports are, for example, MgO, CaO, AlPO4, ZrO2, TiO2, B2O3 or mixtures thereof. Further preferred inorganic support materials are inorganic halides such as MgCl2 or carbonates such as Na2CO3, K2CO3, CaCO3, MgCO3, sulfates such as Na2SO4, Al2(SO4)3, BaSO4, nitrates such as KNO3, Mg(NO3)2 or Al(NO3)3.

The inorganic support is preferably subjected to a thermal treatment, e.g. to remove adsorbed water. Such a calcination treatment is generally carried out at temperatures in the range from 50 to 1000° C., preferably from 100 to 600° C., with drying at from 100 to 200° C. preferably being carried out under reduced pressure and/or under a blanket of inert gas (e.g. nitrogen), or the inorganic support can be calcined at temperatures of from 200 to 1000° C. to produce the desired structure of the solid and/or set the desired OH concentration on the surface. The support can also be treated chemically using customary dessicants such as metal alkyls preferably aluminum alkyls, chlorosilanes or SiCl4, or else methylaluminoxane. Appropriate treatment methods are described, for example, in WO 00/31090.

The inorganic support material can also be chemically modified. For example, treatment of silica gel with NH4SiF6 or other fluorinating agents leads to fluorination of the silica gel surface, or treatment of silica gels with silanes containing nitrogen-, fluorine- or sulfur-containing groups leads to correspondingly modified silica gel surfaces.

Strong preference is given to using silica gels since particles whose size and structure make them suitable as supports for olefin polymerization can be produced from this material. Spray-dried silica gels, which are spherical agglomerates of relatively small granular particles, i.e. primary particles, have been found to be particularly useful. The silica gels can be dried and/or calcinated before use.

Further preferred supports (D) are calcined hydrotalcites. In mineralogy, hydrotalcite is a natural mineral having the ideal formula

Mg6Al2(OH)16CO3.4H2O

whose structure is derived from that of brucite Mg(OH)2. Brucite crystallizes in a sheet structure with the metal ions in octahederal holes between two layers of close-packed hydroxyl ions, with only every second layer of the octahederal holes being occupied. In hydrotalcite, some magnesium ions are replaced by aluminum ions, as a result of which the packet of layers gains a positive charge. This is balanced by the anions which are located together with water of crystallization in the layers in-between. Calcination, i.e. transformation of the structure, can be confirmed, for example, by means of X-ray diffraction patterns. The calcined hydrotalcites or silica gels used are generally used as finely divided powders having a mean particle diameter D50 of from 5 to 200 μm, and usually have pore volumes of from 0.1 to 10 cm3/g and specific surface areas of from 30 to 1000 m2/g. The metallocene complex (A) is preferably applied in such an amount that the concentration of the transition metal from the transition metal complex (A) in the finished catalyst system is from 1 to 100 μmol per g of support (D).

To prepare the polyethylene of the invention, the ethylene is polymerized as described above with olefines, preferably 1-alkenes or 1-olefines, having from 3 to 20 carbon atoms, preferably having from 3 to 10 carbon atoms. Preferred 1-alkenes are linear or branched C3-C10-1-alkenes, in particular linear 1-alkenes, such as ethene, propene, 1-butene, 1-pentene, 1-hexene, 1-heptene, 1-octene or branched 1-alkenes such as 4-methyl-1-pentene. Particularly preferred are C4-C10-1-alkenes, in particular linear C6-C10-1-alkenes. It is also possible to polymerize mixtures of various 1-alkenes. Preference is given to polymerizing at least one 1-alkene selected from the group consisting of ethene, propene, 1-butene, 1-pentene, 1-hexene, 1-heptene, 1-octene and 1-decene. Where more than one comonomer is employed, preferably one comonomer is 1-butene and a second comonomer is a C5-C10-alkene, preferably is 1-hexene, 1-pentene or 4-methyl-1-pentene; ethylene-1-buten-5-C10-1-alkene terpolymers are one preferred embodiment. Preferably the weight fraction of such comonomer in the polyethylene is in the range of from 0.1 to 20% by weight, typically about 5-15% at least in the first product fraction synthesized by the transition metal catalyst A) and corresponding to the or one % LT peak fraction.

The process of the invention for polymerizing ethylene with 1-alkenes can be carried out using industrial, essentially commonly known gas phase polymerization methodoloy. Such process, especially fluidised bed gas phase processes, are described e.g. in WO 99/60036, FR2207145, FR 2335526, EP-699213, U.S. Pat. No. 5,352,749, all incorporated herewith by reference. It can be carried out batchwise or, preferably, continuously in one or more stages, most preferably continously in a single reactor. Particular preference is given to gas-phase fluidized-bed reactor. It is possible to divide the recycle gaseous stream into a first stream and a second stream. The first stream is passed directly to the reactor in a conventional way by injection below the fluidised grid and the second stream is cooled and the stream is separated into a gas and a liquid polymer stream. Said gas stream is preferably then returned to the first stream, injected into the bed. The fluidising medium may optionally and preferably comprise inert hydrocarbonds or inert gases, e.g. ethane, isobutane, nitrogen. Beside, it may comprises moderators of catalyst activity, such as e.g. hydrogen for controlling the mass distribution of the product of a metallocene catalyst (A). Preferably, the gas phase polymerisation of the present invention is not carried out with an active Ziegler catalyst being involved in the polymerisation reaction. It is further possible and preferred to use an antistatic agent during gas phase polymerisation, which may either be injected into the reactor, e.g. along with the gas stream or may be added to the catalyst particles, e.g. during prepolymerisation. Examples of suitable antistatic agents are those described in U.S. Pat. No. 5,283,278, incorporated herewith by reference. It is also possible, for controlling excessive wall temperature increase effects trespassing the average bed temperature, to temporarily add deactivating agent such as e.g. carbon dioxide to the reactor, as described in WO99/60036. The gas-phase polymerization according to the present invention is preferably carried out in the range from 30 to 125° C., more preferably of from 80 to 100° C., and at pressures of from 1 to 50 bar, more preferably of from 15 to 30 bar.

As said before, it is possible and preferred for the catalyst system firstly to be prepolymerized with olefin, preferably C2-C10-1-alkenes and in particular ethylene, and the resulting prepolymerized catalyst solid then to be used in the actual polymerization. Details of prepolymerisation can be inferred from U.S. Pat. No. 4,922,833, U.S. Pat. No. 5,283,278, U.S. Pat. No. 4,921,825 or EP-279 863, all of which are incoporated herwith by reference. Prepolymerisation, optional to or in combination with choice of sufficient particle size of solid support material as recommended in EP-882077 as an exclusive measure, incorporated herewith, prepolymerisation will help to provide for sufficient catalyst particle size at the onset of gas phase operation, which is important for providing controllable gas flow conditions at onset and helps to reduce undesireable fines. Fines may interfer with reactor operation by clogging installations and removing catalyst from the gas stream by filling of small cavities in the reactor walls. Accordingly, any mentioning of minimal particle size to be obtained from/in the reactor according to the claims, encompasses presetting catalyst particle size by prepolymeristion, choice of support particle size or a combination thereof. Prepolymerisation is most preferred for achieving a sufficient particle size at the onset of gas phase polymerisation, most preferably for providing the reactor substantially with catalyst particles having at least an average particle size of >0.3 mm, more preferably of >1 mm. The mass ratio of catalyst solid used in the prepolymerization to a monomer polymerized onto it is usually in the range from 1:0.1 to 1:1000, preferably from 1:1 to 1:200. Furthermore, a small amount of an olefin, preferably an 1-olefin, for example vinylcyclohexane, styrene or phenyldimethylvinylsilane, as modifying component, an antistatic or a suitable inert compound such as a wax or oil can be added as additive during or after the preparation of the catalyst system. The molar ratio of additives to the sum of transition metal compound (A) and iron complex (B) is usually from 1:1000 to 1000:1, preferably from 1:5 to 20:1.

The gas-phase polymerization may also be carried out in the condensed or supercondensed mode, in which part of the circulating gas is cooled to below the dew point and is recirculated as a two-phase mixture to the reactor. Furthermore, it is possible to use a multizone reactor in which the two polymerization zones are linked to one another and the polymer is passed alternately through these two zones a number of times. The two zones can also have different polymerization conditions. Such a reactor is described, for example, in WO 97/04015. Furthermore, molar mass regulators, for example hydrogen, or customary additives such as antistatics can also be used in the polymerizations. The hydrogen and increased temperature usually lead to lower z-average molar mass, whereby according to the present invention, it is preferably only the single site transition metal complex catalyst A) that is responsive to hydrogen and whose activity is modulated and modulatable by hydrogen.

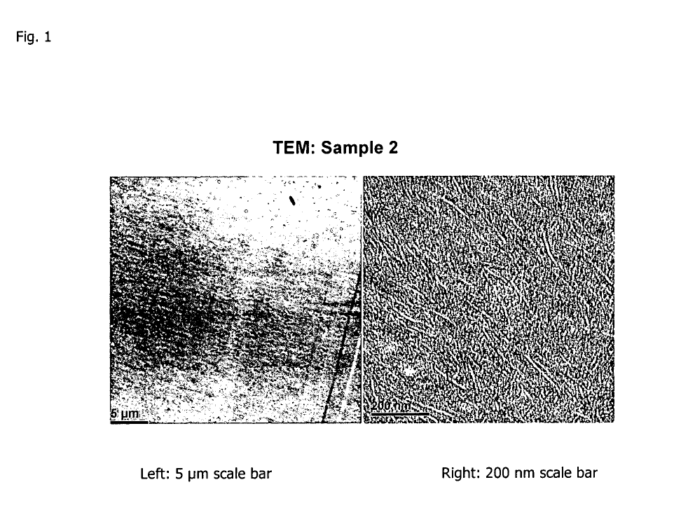

The preparation of the polyethylene of the invention in preferably a single reactor reduces the energy consumption, requires no subsequent blending processes and makes simple control of the molecular weight distributions and the molecular weight fractions of the various polymers possible. Most importantly, excellent, high total yield per mass unit of catalyst is achieved. In addition, good mixing of the polyethylene is achieved, as is demonstrated e.g. by FIG. 1.

The following examples illustrate the invention without restricting the scope of the invention.

### EXAMPLES

Most specific methods have been described or referenced in the foregoing already. NMR samples were placed in tubes under inert gas and, if appropriate, melted. The solvent signals served as internal standard in the 1H- and 13C-NMR spectra and their chemical shift was converted into the values relative to TMS.

The branches/1000 carbon atoms are determined by means of 13C-NMR, as described by James. C. Randall, JMS-REV. Macromol. Chem. Phys., C29 (2&3), 201-317 (1989), and are based on the total content of CH3 groups/1000 carbon atoms. The side chains larger than CH3 and especially ethyl, butyl and hexyl side chain branches/1000 carbon atoms are likewise determined in this way.- The degree of branching in the individual polymer mass fractions is determined by the method of Holtrup (W. Holtrup, Makromol. Chem. 178, 2335 (1977)) coupled with 13C-NMR. -13C-NMR high temperature spectra of polymer were acquired on a Bruker DPX-400 spectrometer operating at 100.61 MHz in the Fourier transform mode at 120 ° C. The peak S55 [C. J. Carman, R. A. Harrington and C. E. Wilkes, Macromolecules, 10, 3, 536 (1977)] carbon was used as internal reference at 29.9 ppm. The samples were dissolved in 1,1,2,2-tetrachloroethane-d2 at 120 ° C. with a 8% wt/v concentration. Each spectrum was acquired with a 90° pulse, 15 seconds of delay between pulses and CPD (WALTZ 16) to remove 1H-13C coupling. About 1500-2000 transients were stored in 32K data points using a spectral window of 6000 or 9000 Hz. The assignments of the spectra, were made referring to Kakugo [M. Kakugo, Y. Naito, K. Mizunuma and T. Miyatake, Macromolecules, 15, 4, 1150, (1982)] and J.C. Randal, Macromol. Chem Phys., C29, 201 (1989).

The melting enthalpies of the polymers (ΔHf) were measured by Differential Scanning calorimetry (DSC) on a heat flow DSC (TA-Instruments Q2000), according to the standard method (ISO 11357-3 (1999)). The sample holder, an aluminum pan, is loaded with 5 to 6 mg of the specimen and sealed. The sample is then heated from ambient temperature to 200° C. with a heating rate of 20 K/min (first heating). After a holding time of 5 minutes at 200° C., which allows complete melting of the crystallites, the sample is cooled to −10° C. with a cooling rate of 20 K/min and held there for 2 minutes. Finally the sample is heated from −10° C. to 200° C. with a heating rate of 20 K/min (second heating). After construction of a baseline the area under the peak of the second heating run is measured and the enthalpy of fusion (ΔHf) in J/g is calculated according to the corresponding ISO (11357-3 (1999)).

The Crystaf® measurements were carried out on an instrument from Polymer Char, P.O. Box 176, E-46980 Paterna, Spain, using 1,2-dichlorobenzene as solvent and the data were processed using the associated software. The Crystaf® temperature-time curve notably allows of quantitating individual peak fractions when integrated. The differential Crystaf® curve shows the modality of the short chain branching distribution. It is also possible but has not worked here to convert the Crystaf® curves obtained into CH3 groups per 1 000 carbon atoms, by using suitable calibration curves depending on the type of comonomer employed.

The density [g/cm3] was determined in accordance with ISO 1183. The vinyl group content is determined by means of IR in accordance with ASTM D 6248-98. Likewise, separately, was measured that of vinyliden groups. The dart drop impact of a film was determined by ASTM D 1709:2005 Method A on films, blown films as described, having a film thickness of 25 μm. The friction coefficient, or coefficient of sliding friction, was measured according to DIN 53375 A (1986),

The haze was determined by ASTM D 1003-00 on a BYK Gardener Haze Guard Plus Device on at least 5 pieces of film 10×10 cm. The clarity of the film was determined acc. to ASTM D 1746-03 on a BYK Gardener Haze Guard Plus Device, calibrated with calibration cell 77.5, on at least 5 pieces of film 10×10 cm. The gloss at different angels was determined acc. to ASTM D 2457-03 on a gloss meter with a vacuum plate for fixing the film, on at least 5 pieces of film.

The determination of the molar mass distributions and the means Mn, Mw, Mz and Mw/Mn derived therefrom was carried out by high-temperature gel permeation chromatography using a method described in DIN 55672-1:1995-02 issue February 1995. The deviations according to the mentioned DIN standard are as follows: Solvent 1,2,4-trichlorobenzene (TCB), temperature of apparatus and solutions 135° C. and as concentration detector a PolymerChar (Valencia, Paterna 46980, Spain) IR-4 infrared detector, suited for use with TCB. For further details of the method, please see the method description set forth in more detail further above in the text; applying the universal calibration method based on the Mark-Houwink constants given may additionally be nicely and comprehensibly inferred in detail from ASTM-6474-99, along with further explanation on using an additional internal standard-PE for spiking a given sample during chromatography runs, after calibration.

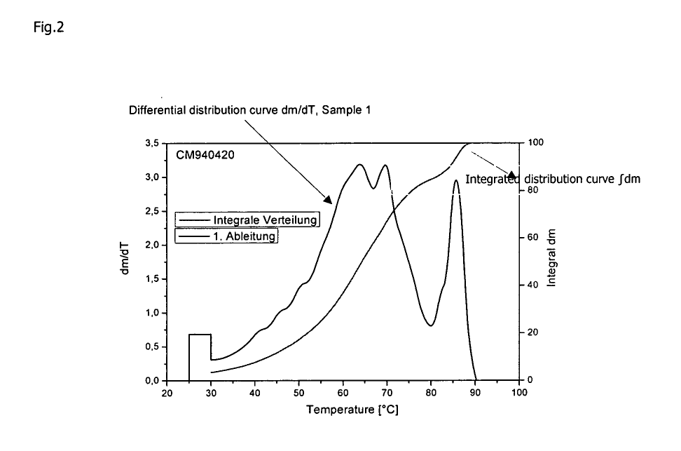

Abbreviations in the table below:
Cat. Catalyst
T(poly) Polymerisation temperature
Mw Weight average molar mass
Mn Number average molar mass
Mz z-average molar mass
Mc critical weight of entanglement
Density Polymer density
Prod. Productivity of the catalyst in g of polymer obtained per g of catalyst used per hour total-CH3 is the amount of CH3-groups per 1000 C including end groups
LT % low temperature weight fraction as determined from CRYSTAF®, determined from the integral curve as the fraction at T<80° C. (see FIG. 2).
HT % high temperature weight fraction as determined from CRYSTAF®, determined from the integral curve as the fraction at T>80° C. (see FIG. 2).

Preparation of the individual components of the catalyst system

Bis(1-n-butyl-3-methyl-cyclopentadienyl)zirconium dichloride is commercially available from Chemtura Corporation 2,6-Bis[1-(2,4,6-trimethylphenylimino)ethyl]pyridine was prepared as in example 1 of WO 98/27124 and reacted in an analogous manner with iron(II) chloride to give 2,6-Bis[1-(2,4,6-trimethylphenylimino)ethyl]pyridine iron(II) dichloride, as likewise disclosed in WO 98/27124.

Preparation of mixed catalyst system on solid support granula & small scale polymerization:

a) Support pretreatment

Sylopol XPO-2326 A, a spray-dried silica gel from Grace, was calcinated at 600° C. for 6 hours

b) Preparation of the mixed catalyst systems & batch polymerization:
b.1 Mixed Catalyst 1

2608 mg of complex 1 and 211 mg of complex 2 were dissolved in 122 ml MAO. That solution was added to 100.6 g of the XPO2326 support above (loading: 60:4 μmol/g) at 0° C.

Afterward the catalytic solution was slowly heated up to RT stirred for two hours. 196 g of catalyst were obtained. The powder had ivory colour. The loading of the complex 1 is 60 micromol/g, that of complex 2 is 4 micromol/g and the Al/(complex 1+complex 2) ratio is 90:1 mol:mol.

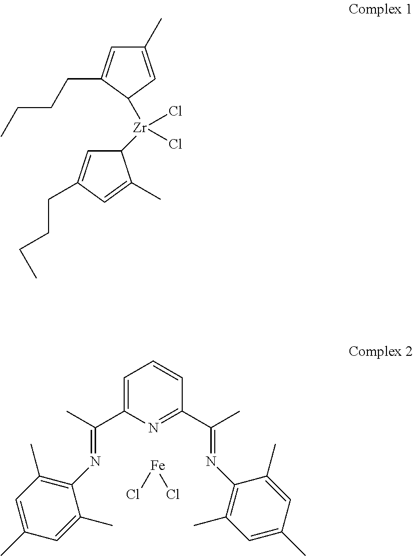

b.2 Mixed Catalyst 2

2620 mg of metallocene complex 1 and 265 mg of Complex 2 were dissolved in 138 ml MAO. That solution were added to 101 g of the XPO2326 support above (loading: 60:5 μmol/g) at 0° C. Afterward the catalytic solution was slowly heated up to RT stirred for two hours. 196 g of catalyst were obtained. The powder had ivory colour. The loading of the complex 1 is 60 micromol/g, that of complex 2 4 micromol/g and the Al/(complex 1+complex 2) ratio is 90:1 mol:mol.

Pilot Scale Gas Phase Polymerization

The polymers were produced in single gas phase reactor. Mixed catalysts 1 and 2 described above were used for trials A) and B) respectively. Comonomer used was 1-hexene. Nitrogen/Propane have been used as inert gas for both trials . Hydrogen was used as a molar mass regulator. Based on proper choice of particle size for the support granula of the mixed catalysts, under the reactor settings given below, always PE powder having an average particle size of >1 mm was obtained, minimizing blocking/fouling of the output mechanism during operation, decreasing electrostatic charge. Control of particle size was a very important parameter for enhancing, in a synergistic fashion with the high mileage of the catalyst and in particular at the given high output rate of the gas phase reactor, operability.

A) Catalyst 1 was run in a continuous gas phase fluidized bed reactor diameter 508 mm Product, in a stable run. Product labeled Sample 1, was produced. Catalyst yield was 10 Kg/g (kg polymer per g catalyst). Ashes were about 0.008 g/100 g.

B) Catalyst 2 was run in continuous gas phase fluidized bed reactor diameter 219 mm, in a stable run. Product, labeled Sample 2 was produced. Catalyst yield was 6.5 Kg/g (kg polymer per g catalyst). Ashes were about 0.009 g/100 g.

Process parameters are reported below in table 3:

TABLE 3

| Run | A/catalyst 1 | B/catalyst 2 |
|---|---|---|
| Sample | 1 | 2 |
| T [° C.] | 85 | 85 |
| P [bar] | 24 | 24 |
| C2H4 [Vol %] | 57 | 64 |
| Inerts [Vol %] | 40 | 35 |
| Propane [Vol %] | 35 | 22 |
| C6/C2 feed [Kg/Kg] | 0.11 | 0.095 |
| Hydrogen feed rate [L/h] | ~15 | ~1.6 |
| Reactor output [kg/h] | 39 | 5 |

Granulation and Film Extrusion

The polymer samples were granulated on a Kobe LCM50 extruder with screw combination E1H. The throughput was 57 kg/h. The gate position of the Kobe was adjusted to have 220° C. of melt temperature in front of the gate. The suction pressure of the gear pump was maintained at 2.5 bar. The revolutions of the rotor were kept at 500 rpm.#

−2000 ppm Hostanox PAR 24 FF, 1000 ppm Irganox 1010 and 1000 ppm Zn-Stearat were added to stabilize the polyethylenes. Material properties are given in Tables 1 and 2.

Film Blowing

The polymer was extruded into films by blown film extrusion on an Alpine HS 50S film line (Hosokawa Alpine AG, Augsburg/Germany) .

The diameter of the annular die was 120 mm with a gap width of 2 mm. A barrier screw with Carlotte-mixing section and a diameter of 50 mm was used at a screw speed equivalent to an output of 40 kg/h. A Temperature profilie from 190° C. to 210° C. was used. Cooling was achieved with HK300 double-lip cooler. The blow-up ratio was in the order of 1:2.5. The height of the frost line was about 250 mm. Films with a thickness of 25 μm were obtained. The optical and mechanical properties of the films are summarized in Table 2. No fluoroelastomer additive was comprised in the films manufactured from the polyethylene composition of the present invention.

Properties of Polymer Products

The properties of the materials thus obtained are tabulated in the tables 1,2 underneath.

TABLE 1

| Sample | A/1 | B/2 |
|---|---|---|
| IV [dl/g] | 2.01 | 1.95 |
| GPC Mw [g/mol] | 117306 | 113220 |
| GPC Mn [g/mol] | 26942 | 32252 |
| GPC Mw/Mn | 4.35 | 3.51 |
| GPC Mz [g/mol] | 464421 | 252789 |
| DSC Tm2 [° C.] | 121.94 | 123.04 |
| DSC 2nd Peak [° C.] | 106 | 105.5 |
| Vinyl Double bonds IR | 0.27 | 0.2 |
| [1/1000C] | | |
| Butyl branches- C6 IR | 7.7 | 7.4 |
| [wt %] | | |
| MFR 2.16 kg [g/10 min] | 1.1 | 1.1 |
| MFR 5 kg [g/10 min] | 2.9 | 3.1 |
| MFR 10 kg [g/10 min] | 6.7 | 7.3 |
| MFR 21.6 kg [g/10 min] | 20.0 | 21.7 |
| Density [g/cm³] | 0.9186 | 0.9202 |
| (% HDPE=) % HT | 15.4 | 20.1 |
| (Crystaf >80° C.) | | |

The wt.-% HDPE or % HT was obtained by Crystaf ®, from the integral curve as the fraction at T >80° C. (see FIG. 2).

FIG. 1 displays transmissions electron microscopy (TEM) pictures of the granulated polyethylene material of the invention as used in the working examples; resolution increases from left to right, as indicated in every picture by the scaling bar in the lower left corner. Left picture allows of distinguishing objects that are in the 2-3 pm range, right picture is the highest resolution allowing distinguishing objects differing by several tens of nm (˜50 nm range). No spherulitic texture is observed (left picture). -At higher magnification crystalline lamellae are evident (right picure). The excellent the mixing quality of the inventive product is evident.

FIG. 2 shows the Crystaf® diagram of the same sample; whilst the distinction of two different, high and low temperature peak fraction is evident from the differential contour plot, peak shape may differ from DSC analysis due to solvent effect as well as does the crystallization temperature. Second graph (ball-on-stick plot) is the integrated form based on which the mass fractions of the high and temperature fractions have been calculated from according to the present invention; arbitrarily, the depression at 80° C. has been set to delimit the high from the low temperature fraction. Hence all numeric values given for the high temperature fraction are calculated from the integral of the Crystaf curve for any temperature >80° C., and vice versa.

Table 2 displays the test results for mechanical and optical tests performed on a blown film produced from the polyethylene sample 1b .

TABLE 2

| Film properties: | A/1 |
|---|---|
| Thickness [μm] | 25 |
| Haze [%] | 11.1 |
| Gloss 60° [%] | 80 |
| Friction coefficient μ | 0.82 |
| (inside/inside, acc. To DIN 53375 A (1986), dimensionless) | |
| Blocking number 70oC (inside/inside) [N] | 77 |
| Dart drop impact (DDI) [g] | >1680 |
| ASTM D1709-A | |
| Tensile strain at Break maschine/transversal direction [%] | 499/524 |
| ISO 527 R-D | |
| Elmendorf tear strength maschine/transversal direction | 480/760 |
| [g/Layer] ISO 6383-2 | |

1. A method for polymerizing ethylene with C3-C20-olefine-comonomer, comprising the step of carrying out the polymerization in a single gas phase reactor with a mixed catalyst system wherein the catalyst system has a catalyst mileage of >6000 g polymer product/g catalyst.

2. The method according to claim 1, wherein the catalyst mileage is >7000 g polymer product/g catalyst.

3. The method according to claim 2, wherein the catalyst mileage is >8000 g polymer product/g catalyst.

4. The method according to claim 1 wherein the mixed catalyst system comprises at least two different catalytic transition metal complexes immobilized on a granulated, solid support.

5. The method according to claim 4, wherein the different transition metal complexes are mixed and immobilized on a common, granulated solid support.

6. The method according to claim wherein the average size of solid product particles harvested from the reactor is >1 mm.

7. The method according to claim 5, wherein the product particles comprise support granula carrying the mixed, immobilized catalyst embedded in polymeric ethylene.

8. The method according to claim 1, wherein the polymerized ethylene comprises a polyethylene copolymer.

9. The method according to claim 8, wherein the polymerized ethylene comprises both an ethylene homo- and copolymer.

10. The method according to claim 1 wherein the gas phase reactor is operated in a continuous mode, having a continous output rate of >1 kg/h.

11. The method according to claim 10, wherein the gas phase reactor has an output rate of >20 kg/h.

12. The method according to claim 4, wherein the total ashes of transition metal in the polymerized ethylene product are <100 ppm (<0.01 g/100 g polymer).

13. The method according to claim 4, wherein at least one first catalytic transition metal complex is a metallocene complex and/or wherein a second one is a non-metallocene complex.

14. The method according to claim 13, wherein no transition metal complex is a Ziegler catalyst.

15. The method according to claim 4, wherein at least one second catalytic transition metal complex is an iron complex catalyst component having a tridentate ligand.

16. The method according to claim 15, wherein the tridentate ligand bears at least two aryl radicals and wherein each of said two aryl radicals bears a halogen and/or an alkyl substituent in the ortho-position.

17. The method according to claim 1, wherein the polymerization in the gas phase reactor is carried out at a temperature of from 65 to 120° C.

18. The method according to claim 1, wherein the comonomer is a C4-C10-olefine.

19. The method according to claim 1, wherein the olefine-comonomer is an α-olefine.

20. The method according to claim 19, wherein the α-olefine comonomer is selected from the group consisting of 1-hexene, 1-octene and mixtures thereof.

21. The method according to claim 24, wherein the metallocene catalyst is a zirconium catalyst complex of the general formula: 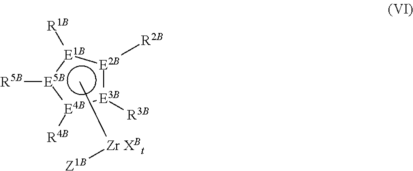
wherein the substituents and indices have the following meanings:
X^{B} is fluorine, chlorine, bromine, iodine, hydrogen, C₁-C₁₀-alkyl, C₂-C₁₀-alkenyl, C₆-C₁₅-aryl, alkylaryl having from 1 to 10 carbon atoms in the alkyl part and from 6 to 20 carbon atoms in the aryl part, —OR^{6B} or —NR^{6B}R^{7B}, or two radicals X^{B} form a substituted or unsubstituted diene ligand, and the radicals X^{B} are identical or different and may be joined to one another,
E^{1B}-E^{5B} are each carbon or not more than one E^{1B} to E^{5B} is phosphorus or nitrogen,
t is 1, 2 or 3, depending on the valence of Hf, such that the metallocene complex of the general formula (VI) is uncharged,
further wherein
R^{6B} and R^{7B} are each C₁-C₁₀-alkyl, C₆-C₁₅-aryl, alkylaryl, arylalkyl, fluoroalkyl or fluoroaryl each having from 1 to 10 carbon atoms in the alkyl part and from 6 to 20 carbon atoms in the aryl part and
R^{1B} to R^{5B} are each, independently of one another hydrogen, C₁-C₂₂-alkyl, 5- to 7-membered cycloalkyl or cycloalkenyl which may in turn bear C₁-C₁₀-alkyl groups as substituents, C₂-C₂₂-alkenyl, C₆-C₂₂-aryl, arylalkyl having from 1 to 16 carbon atoms in the alkyl part and from 6 to 21 carbon atoms in the aryl part, NR^{8B}₂, N(SiR^{8B}₃)₂, OR^{8B}, OSiR^{8B}₃, SiR^{8B}₃, wherein the organic radicals R^{1B}-R^{5B} may also be substituted by halogens and/or two radicals R^{1B}-R^{5B} may also be joined to form a five-, six- or seven-membered ring, and/or two vicinal radicals R^{1D}-R^{5D} may be joined to form a five-, six- or seven-membered heterocycle containing at least one atom from the group consisting of N, P, O and S, where
the radicals R^{8B} can be identical or different and can each be C₁-C₁₀-alkyl, C₃-C₁₀-cycloalkyl, C₆-C₁₅-aryl, C₁-C₄-alkoxy or C₆-C₁₀-aryloxy and Z^{1B is X}^{B} or is of formula 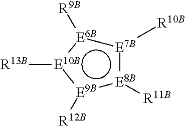
wherein the radicals
R^{9B} to R^{13B} are each, independently of one another, hydrogen, C₁-C₂₂-alkyl, 5- to 7-membered cycloalkyl or cycloalkenyl which may in turn bear C₁-C₁₀-alkyl groups as substituents, C₂-C₂₂-alkenyl, C₆-C₂₂-aryl, arylalkyl having from 1 to 16 carbon atoms in the alkyl part and 6-21 carbon atoms in the aryl part, NR^{14B}₂, N(SiR^{14B}₃)₂, OR^{14B}, OSiR14B₃, SiR^{14B}₃, where the organic radicals R^{9B}-R^{13B} may also be substituted by halogens and/or two radicals R^{9B}-R^{13B} may also be joined to form a five-, six- or seven-membered ring, and/or two vicinal radicals R^{9B}-R^{13B} may be joined to form a five-, six- or seven-membered heterocycle containing at least one atom from the group consisting of N, P, O and S, where
the radicals R^{14B} are identical or different and are each C₁-C₁₀-alkyl, C₃-C₁₀-cycloalkyl, C₆-C₁₅-aryl, C₁-C₄-alkoxy or C₆-C₁₀-aryloxy, and
E^{6B} -E^{10B} are each carbon or not more than one E^{6B} to E^{10B} is phosphorus or nitrogen,

22. The method according to claim 21, wherein Z^{1B} is not X^{B}.

23. The method of claim 4 wherein the mixed catalyst system comprises two different catalytic transition metal complexes immobilized on a granulated, solid support.

24. The method according to claim 21, wherein the metallocene catalyst is a zirconocene polymerization catalyst.

25. The method according to claim 21 wherein X^{B} forms a substituted or unsubstituted 1,3-diene ligand.

26. The method according to claim 21 wherein E^{1B}-E^{5B} are each carbon.

27. The method according to claim 21 wherein two radicals of R^{1B}-R^{5B} joined to form a ring are vicinal radicals.

28. The method according to claim 21 wherein two radicals of R^{9B}-R^{13B} joined to form a ring are vicinal radicals.

29. The method according to claim 21 wherein E^{6B}-E^{10B} are each carbon.

30. The method according to claim 11, wherein the gas phase reactor has an output rate of >30 kg/h.
